(19) United States
(12) Patent Application Publication
(10) Pub. No.: US 2010/0223228 A1
(43) Pub. Date: Sep. 2, 2010

(54) METHOD AND MOBILE ELECTRONIC DEVICE FOR UPDATING A LOCAL DATABASE FROM A REMOTE DATABASE OVER A WIRELESS NETWORK

(75) Inventors: Adrian LOGAN, Waterloo (CA); Rohit Rocky Jain, Waterloo (CA)

Correspondence Address: PERRY + CURRIER INC.;(FOR RIM), 1300 YONGE STREET, SUITE 500, TORONTO, ON, M4T-1X3, CA

(73) Assignee: RESEARCH IN MOTION LIMITED, Waterloo (CA)

(21) Appl. No.: 12/395,179

(22) Filed: Feb. 27, 2009

(51) Int. Cl. G06F 17/30

(52) U.S. Cl. 707/609; 707/E17.01

(57) ABSTRACT

A method and apparatus for updating a local database at a mobile electronic device, from a remote database over a wireless network is provided. The local database is for storing availability data. First request data is transmitted to the remote database over the wireless network and first availability data for a first time period is subsequently received therefrom. The first availability data comprises data representative of at least a first invitee's availability during the first time period. Second request data is assembled, the second request data for requesting, from the remote database, at least the first invitee's availability during only a second time period. The second request data is transmitted to the remote database. Second availability data is subsequently receiving therefrom, the second availability data comprising data representative of at least the first invitee's availability during only the second time period. The second availability data is stored in the local database if the second availability data is indicative that at least the first invitee is available during the second time period.

### FIELD

The specification relates generally to database applications, and specifically to a method and mobile electronic device for updating a local database from a remote database over a wireless network.

### BACKGROUND

When availability data for a calendar meeting is requested from a mobile electronic device, a request is transmitted to a server, and the server subsequently requests the data from a remote database. However, if data for a new time range is desired, the mobile electronic device sends a new request to the server to get the data; in general the new request is for availability data for both the initial and the new time ranges, and can further include the time range in between the initial and the new time ranges. In some instances a new attendee can be added to a meeting which results in yet another request for further data for the initial and new time periods. Moreover, the requests are sent even for users whose availability was not available when the initial requests were made (for example if those users are not on a common server or database, or outside of a local domain). In general, each of these requests are generally wasteful of bandwidth, which is especially costly in a mobile network.

### BRIEF DESCRIPTIONS OF THE DRAWINGS

Embodiments are described with reference to the following figures, in which:

FIG. 1 depicts a system for updating a local database at a mobile electronic device from a remote database over a wireless network, according to non-limiting embodiments;

FIG. 2 depicts a method for updating a local database at a mobile electronic device from a remote database over a wireless network, according to non-limiting embodiments;

FIG. 3 depicts a representation of a view of a calendar application, according to non-limiting embodiments;

FIG. 4 depicts the system of FIG. 1 in which a request for more availability data is transmitted to a remote database, according to non-limiting embodiments;

FIG. 5 depicts a flow diagram of generation of requests for availability data, according to non-limiting embodiments;

FIG. 6 depicts the system of FIG. 1 in which more availability data is received at the mobile computing device, according to non-limiting embodiments; and

FIG. 7 depicts a representation of a view of a calendar application, according to non-limiting embodiments.

### DETAILED DESCRIPTION OF THE EMBODIMENTS

A first aspect of the specification provides a method for updating a local database at a mobile electronic device, from a remote database over a wireless network, the local database for storing availability data, the method implementable in the mobile electronic device. The method comprises transmitting first request data to the remote database over the wireless network and subsequently receiving therefrom first availability data for a first time period, the first availability data comprising data representative of at least a first invitee's availability during the first time period. The method further comprises assembling second request data for requesting, from the remote database, at least the first invitee's availability during only a second time period. The method further comprises transmitting the second request data, to the remote database and subsequently receiving therefrom second availability data, the second availability data comprising data representative of at least the first invitee's availability during only the second time period. The method further comprises storing the second availability data in the local database if the second availability data is indicative that at least the first invitee is available during the second time period.

Assembling the second request data can occur if the first availability data is indicative that at least the first invitee is not available during the first time period.

The method can further comprise: assembling third request data for requesting, from the remote database, at least a second invitee's availability during only the second time period; transmitting the third request data to the remote database and subsequently receiving third availability data therefrom, the third availability data comprising data representative of at least the second invitee's availability during only the second time period; and storing the second and third availability data in the local database if the second and third availability data are respectively indicative that at least the first and second invitee are each available during the second time period.

The second request data can comprise data for requesting at least a second invitee's availability during only the second time period. The second availability data can further comprise data representative of at least the second invitee's availability during only the second time period. Storing the second availability data in the local database can occurs if the second availability data is indicative that at least the first and second invitee are each free during the second time period.

The first availability data can further comprise an indication that no data representative of a second invitee's availability is available, and the second request data can exclude data associated with the second invitee.

The first time period and the second time period can be adjacent time periods.

The first time period and the second time period can each comprise a respective predefined time interval.

The second time period can occur one of prior to or later than the first time period.

A second aspect of the specification provides a mobile electronic device. The mobile electronic device comprises an interface for communicating with a remote database over a wireless network. The mobile electronic device further comprises a memory for storing a local database, the local database for storing availability data. The mobile electronic device further comprises an input device for receiving input data. The mobile electronic device further comprises a processing unit interconnected with the interface and the memory. The processing unit is enabled to transmit first request data to the remote database over the wireless network and subsequently receive therefrom first availability data for a first time period, the first availability data comprising data representative of at least a first invitee's availability during the first time period. The processing unit is further enabled to assemble second request data for requesting, from the remote database, at least the first invitee's availability during only the second time period. The processing unit is further enabled to transmit the second request data, to the remote database and subsequently receive therefrom second availability data, the second availability data comprising data representative of at least the first invitee's availability during only the second time period. The second availability data is stored in the local database if the second availability data is indicative that at least the first invitee is available during the second time period.

The processing unit can be further enabled to assemble the second request data if the first availability data is indicative that at least the first invitee is not available during the first time period.

The processing unit can be further enabled to: assemble third request data for requesting, from the remote database, at least a second invitee's availability during only the second time period; transmit the third request data to the remote database and subsequently receive therefrom third availability data, via the interface, the third availability data comprising data representative of at least the second invitee's availability during only the second time period; and store the second and third availability data in the local database if the second and third availability data are respectively indicative that at least the first and second invitee are each available during the second time period.

The second request data can comprise data for requesting at least a second invitee's availability during only the second time period. The second availability data can further comprise data representative of at least the second invitee's availability during only the second time period. The processing unit can be further enabled to store the second availability data in the local database if the second availability data is indicative that at least the first and second invitee are each free during the second time period.

The first availability data can further comprise an indication that no data representative of a second invitee's availability is available, and the second request data can exclude data associated with the second invitee.

The first time period and the second time period can be adjacent time periods.

The first time period and the second time period can each comprise a respective predefined time interval.

The second time period can occur one of prior to or later than the first time period.

A third aspect of the specification provide a computer-readable medium for storing computer-readable code embodied therein, the computer-readable code being executable by a processor of a computing device for causing the computing device to: transmit first request data, to a remote database over a wireless network and subsequently receive therefrom, first availability data for a first time period, the first availability data comprising data representative of at least a first invitee's availability during the first time period; assemble second request data for requesting, from the remote database, at least the first invitee's availability during only the second time period; transmit the second request data to the remote database and subsequently receive therefrom second availability data, the second availability data comprising data representative of at least the first invitee's availability during only the second time period; and store the second availability data in the local database if the second availability data is indicative that at least the first invitee is available during the second time period.

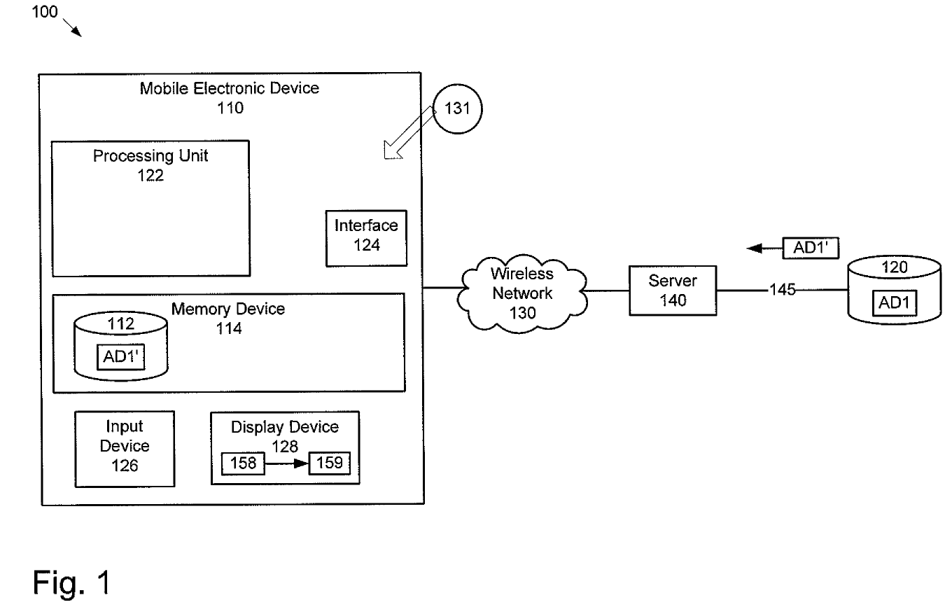

FIG. 1 depicts a system 100 for updating a local database 112 at a mobile electronic device 110 from a remote database 120 over a wireless network 130, the local database 112 and remote database 130 for storing availability data AD1′ and AD1, respectively. In general, availability data AD1′ stored at the local database 112 is a subset of availability data AD1. Mobile electronic device 110 comprises a processing unit 122, a communications interface 124 and memory device 114, all in communication, for example, via a computing bus. Mobile electronic device 110 further comprises an input device 126 and a display device 128. Remote database 120 generally comprises availability data AD1 for a plurality of potential invitees for meetings, such that availability of the potential invitees can be determined by requesting and processing the availability data AD1 stored at remote database 120. As such, mobile electronic device 110 is generally enabled to send requests for a subset of availability data AD1 to remote database 120 and subsequently receive availability data AD1′ from remote database 120 via wireless network 130. In general, data exchanged between mobile electronic device 110 and remote database 120 occurs via a server 140, which is in communication with mobile electronic device 10 via wireless network 130 and with remote database 120 via a link 145.

In particular, mobile electronic device 110 is enabled to request and receive availability data AD1′ via an application 131 which can be stored in memory device 114 and processed by processing unit 122. In particular non-limiting embodiments, application 131 comprises a calendaring application, as described below.

Mobile electronic device 110 comprises any suitable computing device for requesting and receiving availability data AD1′, and for processing application 131, including but not limited to any suitable combination of laptops, PDATS, cell phones and the like. Other suitable types of mobile electronic devices are within the scope of present embodiments.

Communications interface 124 is enabled to request and receive availability data AD1′, under control of processing unit 122, via wireless network 130. Accordingly, communications interface 124 is enabled to communicate via wireless network 130 according to any suitable protocol which is compatible with wireless network 130, including but not limited to packet based protocols, Internet protocols, analog protocols, cell phone protocols (IX, UTMS, CDMA, GMS, and the like), WiFi protocols, WiMax protocols and/or a combination. Other suitable protocols are within the scope of present embodiments.

Similarly, wireless network 130 can comprise any suitable wireless networks, including but not limited to packet based networks, the Internet, analog networks, the PSTN, LAN, WAN, cell phone networks, WiFi networks, WiMax networks and/or a combination. Other suitable types of wireless networks are within the scope of present embodiments.

Display module 128 comprises circuitry 158 for generating a representation 159 of calendar application 131 and/or availability data AD1′. Display module 128 can include any suitable combination of CRT and/or flat panel displays (e.g. LCD, plasma and the like), and circuitry 158 can include any suitable combination of circuitry for controlling the CRT and/or flat panel displays etc., including but not limited to display buffers, transistors, electron beam controllers, LCD cells, plasmas cells, phosphors etc. In particular, display module 128 and circuitry 158 can be controlled by processing unit 122 to generate representation 159.

Input device 126 is generally enabled to receive input data, and can comprise any desired combination of suitable input devices, including but not limited to a keyboard, a pointing device, a mouse, a track wheel, a touchpad, a touch screen and the like. In alternative embodiments input data can be received at mobile electronic device 110 via communications interface 124 and/or wireless network 130, for example from server 140.

Memory device 114 can be any suitable combination of volatile and non-volatile memory, RAM, ROM and the like.

Database 120 can be implemented in any suitable computing device, and though not depicted it is understood that such a computing device can comprise a processing unit, memory, communication interface etc. Furthermore, database 120 is generally enabled to receive requests for availability data AD1′ and to subsequently transmit available data AD1′ to mobile electronic device 110. In particular non-limiting embodiments, database 120 can reside at a Microsoft™ Exchange Server.

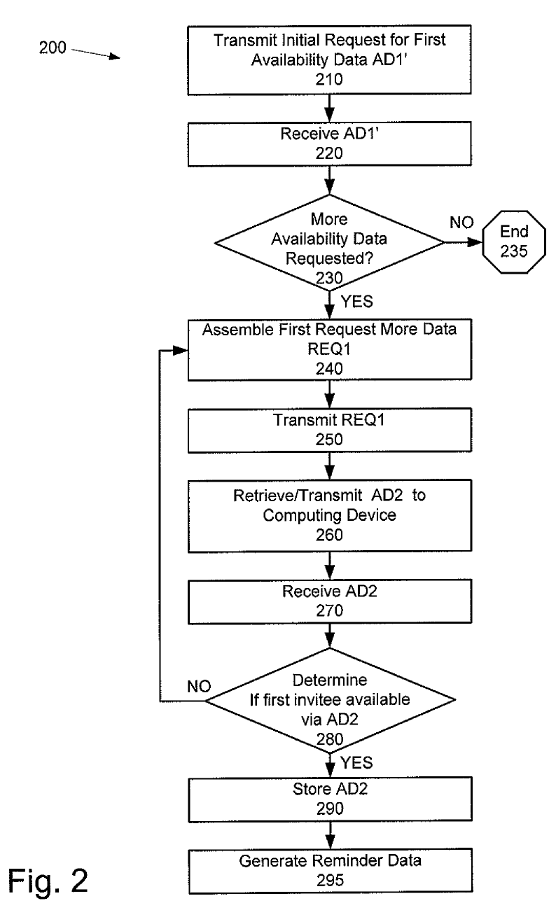

Attention is now directed to FIG. 2 which depicts a method 200 for updating a local database at a mobile electronic device from a remote database over a wireless network, the local database for storing availability data. In order to assist in the explanation of the method 200, it will be assumed that the method 200 is performed using the system 100. Specifically, method 200 is implementable in mobile computing device 110. Furthermore, the following discussion of the method 200 will lead to a further understanding of the system 100 and its various components. However, it is to be understood that the system 100 and/or the method 200 can be varied, and need not work exactly as discussed herein in conjunction with each other, and that such variations are within the scope of present embodiments.

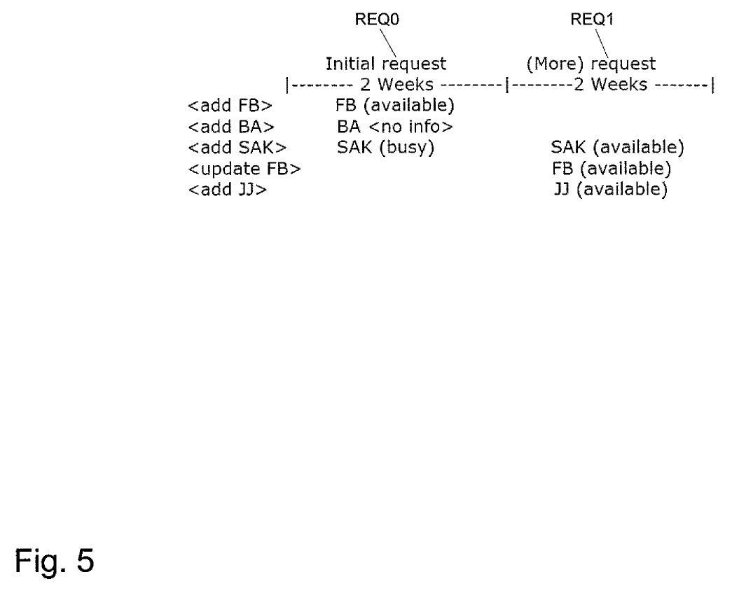

At step 210, an initial request REQ0 for first availability data AD1′ for a first time period is transmitted to remote database 120 over wireless network 130 (as depicted in FIG. 5), initial request REQ0 generated by mobile electronic device 110. First availability data AD1′ generally comprises data representative of at least the first invitee's availability during the first time period. For example, calendar application 131 can be processed by processing unit 122 to invite invitees to a calendared meeting, represented by calendar data which can be stored in local database 112. Availability data AD1′ is requested in order to determine each invitee's availability for the calendared meeting. As described above, it is understood that remote database 120 comprises availability data AD1 for a plurality of potential invitees to meetings. Hence, upon receiving a request for availability data AD1′ for at the first invitee, remote database 120 retrieves the subset of availability data AD1 representative of availability AD1′ and transmits availability data AD1′ back to mobile electronic device 110, where it is received at step 220. The remote database 120 can identify the pertinent subset from an identifier (or identifiers) present in the request for the first availability data AD1.

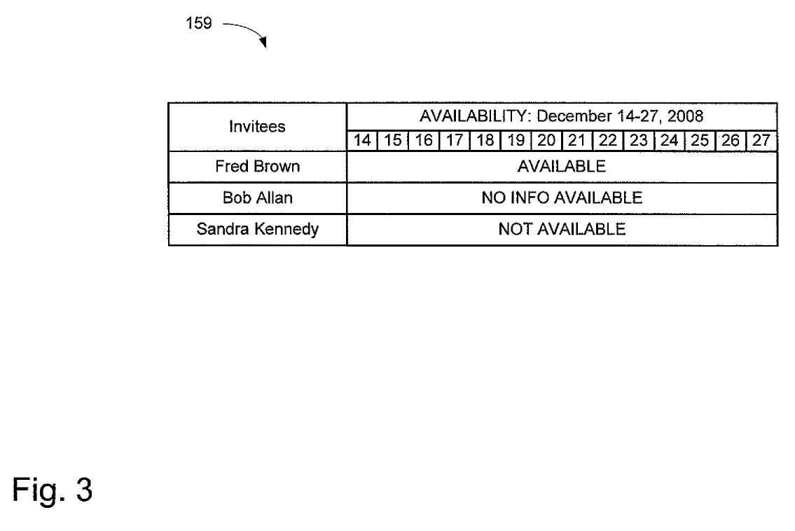

At step 230, it can be determined that more availability data is to be requested. In some embodiments, more availability data is to not be requested, and method 200 ends at step 235. In other embodiments, input data can be received from input device 126 indicative that more availability data is to be requested. For example display device 128 can be controlled to display a representation 259, depicted in FIG. 3, which comprises an indication of the availability of invitees to a meeting during the first time period. In some embodiments, representation 159 can comprise representation 259; e.g. representation 259 can be a particular view of representation 159 (i.e. of calendar application 131). In the depicted embodiment, representation 259 depicts the availability of three invitees (“Fred Brown”, “Bob Allan” and “Sandra Kennedy”) to a meeting during the first time period (Dec. 14-27, 2008). As depicted, Fred Brown is available during the first time period, Sandra Kennedy is unavailable, and there is no information available for Bob Allan. It is further understood that representation 259 is derived by processing availability data AD1′. It is yet further understood, that when availability data AD1′ is requested from database 120, initial request REQ0 for availability data AD1′ generated by mobile electronic device 110 comprises data representative of the first time period and identifiers of the invitees such that database 120 can determine availability data AD1′ (e.g. identifiers of Fred Brown, Bob Allan, Sandra Kennedy, which can comprise their names, an employee number, an e-mail address, or any other suitable identifier and/or a combination) during the first time period.

In any event, in these embodiments, receiving input data from input device 126 indicative that more availability data is to be requested can be responsive to controlling display device 128 to generate representation 259, for example, once it is determined that “Sandra Kennedy” is not available during the first time period.

Alternatively, it can be determined at step 230 that at least the first invitee (e.g. Sandra Kennedy) is not available during the first time period, and hence, more availability data is to be requested to determine another time where at least the first invitee is available. In these embodiments, such a determination can be made by processing availability data AD1′, without receipt of input data.

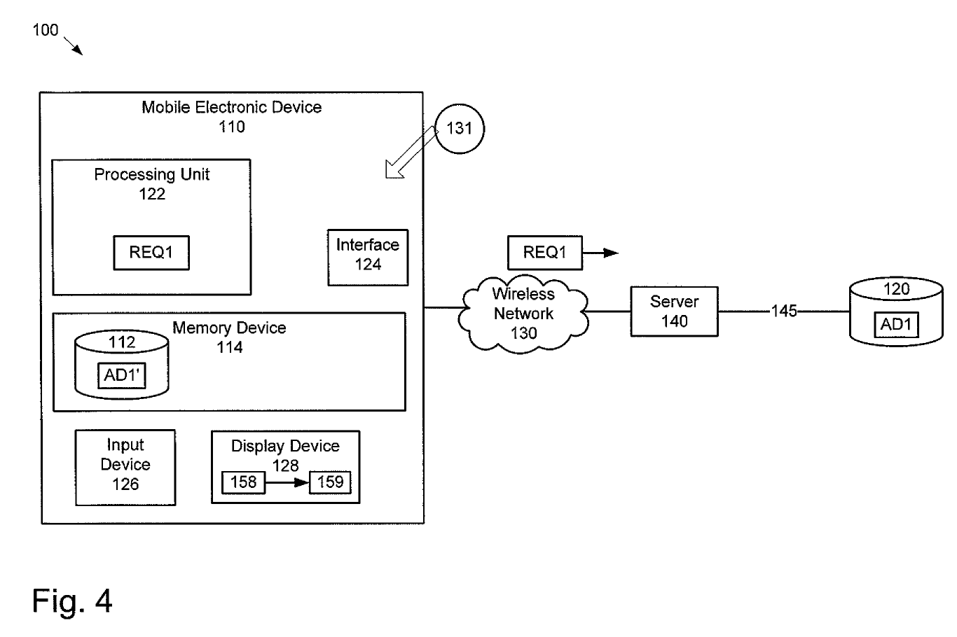

In any event, if more availability data is to be requested, at step 240 first request more data REQ1 is assembled (as depicted in FIG. 4), first request for more data REQ1 for requesting at least the first invitee's availability during only the second time period, from the remote database 120. The availability of at least the first invitee during other time periods, including the first time period, is not requested, as the availability of at least the first invitee during other time periods is not currently of interest.

Attention is now directed to FIG. 5, which depicts a flow diagram of initial request REQ0 and first request for more data REQ1. As depicted, initial request REQ0 is generated once “Fred Brown” (“FB”), “Bob Allan” (“BA”) and “Sandra Kennedy” (“SAK”) are added to a meeting invitation, and REQ0 comprises a request for their availability during the first time period, which as depicted in FIG. 5 is a two week time period (e.g. Dec. 14-27, 2008). As Sandra Kennedy is busy, first request for more data REQ1 is generated, for the second time period, which in some embodiment can be the adjacent two week period ((e.g. Dec. 28, 2008-Jan. 10, 2009). In the depicted embodiment, as no information is available for Bob Allan during the first time period, no further availability data is requested for Bob Allan during the second time period. Furthermore, a new invitee “JJ” (e.g. “John Johnson”) can be added to the meeting, and first request for more data REQ1 can comprise a request for the availability of JJ during the second time period only. JJ's availability during the first time period is not requested as it has already been determined that at least one other invitee is not available during the first time period.

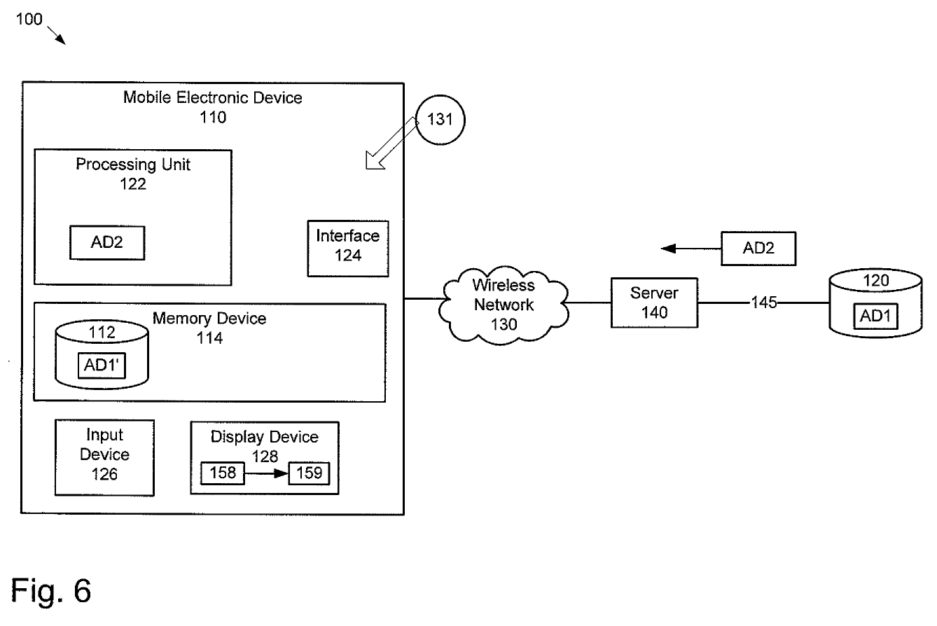

At step 250, first request data REQ1 is transmitted to remote database 120. At step 260, after receiving first request data REQ1, remote database 120 retrieves and transmits second availability data AD2 to mobile computing device 110 (as depicted in FIG. 6) via link 145 and wireless network 120, as described above with respect to first availability data AD1. As only availability data for the second time period is requested and transmitted, the amount of bandwidth used to transmit availability data AD2 back to mobile electronic device 110 is reduced.

At step 270, second availability data AD2 is subsequently receiving from remote database 120, the second availability data comprising data representative of at least the first invitee's availability during only the second time period.

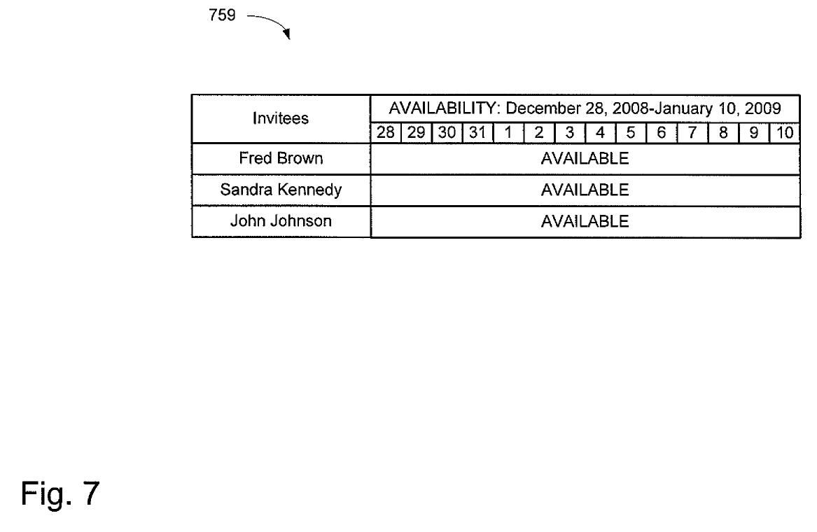

At step 280, it is determined if at least the first invitee is available during the second time period by processing second availability data AD2. In some of these embodiments, display device 128 can be subsequently controlled to generate representation 759, as depicted in FIG. 7, similar to representation 359, for the second time period (Dec. 28, 2008-Jan. 10, 2009). From FIG. 7, it is understood that Fred Brown, Sandra Kennedy and John Johnson are available during the second time period. John Johnson's availability during the first time period is unknown as it was not requested, but is irrelevant in any event as it has already been determined that Sandra Kennedy is not available during the first time period and hence a meeting is not possible during the first time period.

If at step 280, it is determined if at least the first invitee is available during the second time period, then second availability data AD2 is stored the in local database 112 at step 290. If not, step 240 is repeated and a second request for more data is transmitted to the database 120, similar to first request REQ1, for data representative of the invitee's availability during a third time period (e.g. the next adjacent two weeks, or another time period), such that third availability data is received, representative of invitees' availability during the third time period. It is understood that steps 240 through 280 can be repeated until availability data is received which is indicative that all invitees are free during a given time period. The meeting can then be scheduled and meeting data stored in database 112.

Reminder data can then be generated by processing second availability data AD2 and/or meeting data at step 295, such that display device 128 is controlled to generate a representation of reminder data.

In alternative embodiments, method 200 can further comprise assembling second request data, similar to first request data REQ1, for requesting at least a second invitee's availability (e.g. John Johnson) during only the second time period, from the remote database 120, for example to add a new invitee after the availability of the original invitees has been determined during the second time period. The second request data can be transmitted to remote database 120, and third availability data can be subsequently received there from, third availability data comprising data representative of at least second invitee's availability during only the second time period. Second and third availability data can then be stored in local database 112 if second and third availability data are indicative that at least a first and second invitee, respectively, are available during the second time period.

In some alternative embodiments, the first time period and the second time period are adjacent time periods. In other alternative embodiments, the first time period and the second time period each comprise a respective predefined time interval (e.g. the above described two week blocks). It is understood that the predefined time interval of each of the first and second time periods can be the same or different. It is further understood that when availability data for a new given time period is requested, the time interval of the new given time period can be defined in the appropriate request (e.g. request REQ1).

It is further understood that the second time period can occurs one of prior to or later than a first time period. For example, if a meeting is to be held several months hence, and the invitees are not available during the first time period, the second time period can be prior to the first time period.

Those skilled in the art will appreciate that in some embodiments, the functionality of mobile electronic device 110 can be implemented using pre-programmed hardware or firmware elements (e.g., application specific integrated circuits (ASICs), electrically erasable programmable read-only memories (EEPROMs), etc.), or other related components. In other embodiments, the functionality of mobile electronic device 110 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Alternatively, the computer-readable program code could be stored remotely but transmittable to these components via a modem or other interface device connected to a network (including, without limitation, the Internet) over a transmission medium. The transmission medium can be either a non-wireless medium (e.g., optical and/or digital and/or analog communications lines) or a wireless medium (e.g., microwave, infrared, free-space optical or other transmission schemes) or a combination thereof.

A portion of the disclosure of this patent document contains material which is subject to copyright protection. The copyright owner has no objection to the facsimile reproduction by any one the patent document or patent disclosure, as it appears in the Patent and Trademark Office patent file or records, but otherwise reserves all copyrights whatsoever.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

What is claimed is:

1. A method for updating a local database at a mobile electronic device, from a remote database over a wireless network, said local database for storing availability data, said method implementable in said mobile electronic device, said method comprising:
transmitting first request data to said remote database over said wireless network and subsequently receiving therefrom first availability data for a first time period, said first availability data comprising data representative of at least a first invitee's availability during said first time period;
assembling second request data for requesting, from said remote database, at least said first invitee's availability during only a second time period;
transmitting said second request data, to said remote database and subsequently receiving therefrom second availability data, said second availability data comprising data representative of at least said first invitee's availability during only said second time period;
storing said second availability data in said local database if said second availability data is indicative that at least said first invitee is available during said second time period.

2. The method of claim 1, wherein said assembling said second request data occurs if said first availability data is indicative that at least said first invitee is not available during said first time period.

3. The method of claim 1, further comprising:
assembling third request data for requesting, from said remote database, at least a second invitee's availability during only said second time period;
transmitting said third request data to said remote database and subsequently receiving third availability data therefrom, said third availability data comprising data representative of at least said second invitee's availability during only said second time period; and
storing said second and third availability data in said local database if said second and third availability data are respectively indicative that at least said first and second invitee are each available during said second time period.

4. The method of claim 1, wherein:
said second request data comprises data for requesting at least a second invitee's availability during only said second time period;
said second availability data further comprises data representative of at least said second invitee's availability during only said second time period; and
said storing said second availability data in said local database occurs if said second availability data is indicative that at least said first and second invitee are each free during said second time period.

5. The method of claim 1, wherein said first availability data further comprises an indication that no data representative of a second invitee's availability is available, and said second request data excludes data associated with said second invitee.

6. The method of claim 1, wherein said first time period and said second time period are adjacent time periods.

7. The method of claim 1, wherein said first time period and said second time period each comprise a respective predefined time interval.

8. The method of claim 1, wherein said second time period occurs one of prior to or later than said first time period.

9. A mobile electronic device comprising:
an interface for communicating with a remote database over a wireless network;
a memory for storing a local database, said local database for storing availability data;
an input device for receiving input data; and
a processing unit interconnected with said interface and said memory, said processing unit enabled to:
transmit first request data to said remote database over said wireless network and subsequently receive therefrom first availability data for a first time period, said first availability data comprising data representative of at least a first invitee's availability during said first time period;
assemble second request data for requesting, from said remote database, at least said first invitee's availability during only said second time period;
transmit said second request data, to said remote database and subsequently receive therefrom second availability data, said second availability data comprising data representative of at least said first invitee's availability during only said second time period; and
store said second availability data in said local database if said second availability data is indicative that at least said first invitee is available during said second time period.

10. The mobile computing device of claim 9, wherein said processing unit is enabled to assemble said second request data if said first availability data is indicative that at least said first invitee is not available during said first time period.

11. The mobile computing device of claim 9, said processing unit further enabled to:
assemble third request data for requesting, from said remote database, at least a second invitee's availability during only said second time period;
transmit said third request data to said remote database and subsequently receive therefrom third availability data, via said interface, said third availability data comprising data representative of at least said second invitee's availability during only said second time period; and
store said second and third availability data in said local database if said second and third availability data are respectively indicative that at least said first and second invitee are each available during said second time period.

12. The mobile computing device of claim 9, wherein
said second request data comprises data for requesting at least a second invitee's availability during only said second time period;
said second availability data further comprises data representative of at least said second invitee's availability during only said second time period; and
said processing unit is farther enabled to store said second availability data in said local database if said second availability data is indicative that at least said first and second invitee are each free during said second time period.

13. The mobile computing device of claim 9, wherein said first availability data further comprises an indication that no data representative of a second invitee's availability is available, and said second request data excludes data associated with said second invitee.

14. The mobile computing device of claim 9, wherein said first time period and said second time period are adjacent time periods.

15. The mobile computing device of claim of claim 9, wherein said first time period and said second time period each comprise a respective predefined time interval.

16. The mobile computing device of claim 9, wherein said second time period occurs one of prior to or later than said first time period.

17. A computer-readable medium for storing computer-readable code embodied therein, the computer-readable code being executable by a processor of a computing device for causing said computing device to:
transmit first request data, to a remote database over a wireless network and subsequently receive therefrom, first availability data for a first time period, said first availability data comprising data representative of at least a first invitee's availability during said first time period;
assemble second request data for requesting, from said remote database, at least said first invitee's availability during only said second time period;
transmit said second request data to said remote database and subsequently receive therefrom second availability data, said second availability data comprising data representative of at least said first invitee's availability during only said second time period; and
store said second availability data in said local database if said second availability data is indicative that at least said first invitee is available during said second time period.
